(19) United States
(12) Patent Application Publication
(10) Pub. No.: US 2025/0382824 A1
(43) Pub. Date: Dec. 18, 2025

(54) ADJUSTABLE ESCUTCHEON PLATE

(71) Applicant: GLOBAL MATERIAL TECHNOLOGIES, INCORPORATED, Buffalo Grove, IL (US)

(72) Inventor: WESTON KOENNECKE, OAK PARK, IL (US)

(73) Assignee: GLOBAL MATERIAL TECHNOLOGIES, INCORPORATED, Buffalo Grove, IL (US)

(21) Appl. No.: 18/743,237

(22) Filed: Jun. 14, 2024

(51) Int. Cl. E05B 15/02

(52) U.S. Cl. CPC E05B 15/024

(57) ABSTRACT

An adjustable escutcheon plate has an aperture that is expandable and contractible. The adjustable escutcheon plate includes at least two face plates and at least two rear plates, interlockable together to form a body of the escutcheon plate. The aperture is expandable and contractible along a first axis and a second axis, with the first axis and the second axis being orthogonal to each other. Wall anchors are releasably attachable to the body to secure the body to an adjacent drywall surface.

### BACKGROUND OF THE INVENTION

### 1. Field of the Invention

The present application relates, in general to escutcheon plates, and more particularly to an adjustable escutcheon plate having an aperture that is expandable and contractible in multiple dimensions.

### 2. General Background of the Invention

Escutcheon plates have multiple uses. Within homes and businesses, they often serve an aesthetic purpose, providing an attractive cover where water supply lines exit walls or floors through oversized, roughed-in openings. They can also be used for pest control purposes, serving to seal the gap between roughed-in opening and pipe, conduit, cabling, or other materials passes through a wall or floor opening.

One shortcoming of most escutcheon plates is that they are designed with a fixed-sized aperture, and can thus only closely accommodate a pipe, conduit, or cable of a single diameter. Moreover, most escutcheon plates have apertures that are only sized to closely accommodate perfectly round objects.

One alternative to address various pipe diameters is called a “pipe boot”, or “Witches Hat”, and is comprised of a rubber cone that can be cut along the cone to create openings of specific sizes. A variation of this is a split boot, used for retrofitting around installed pipes, and is split along one side and sealed onsite using a clamping metal “zipper”. This rubber cone, sometimes mounted in a metal frame has the significant disadvantage that it has a fixed outside diameter, or perimeter, making it impractical and unattractive for smaller pipes and most interior applications.

Accordingly, it is an object of the present invention to provide an escutcheon plate that is adjustable in size.

It is another object of the present invention to provide an escutcheon plate that is adjustable in size in more than one dimension, in order to accommodate objects of various shapes and sizes.

These and other objects and features of the present invention will become apparent in view of the following specification, drawings, and claims.

### BRIEF SUMMARY OF THE INVENTION

The present invention comprises an adjustable escutcheon plate, comprising a body, and an aperture disposed through the body. The aperture is sizeable in both a first dimension and a second dimension, with the second dimension being different than the first dimension. In an embodiment of the invention, the first dimension and the second dimension are orthogonal to each other.

The aperture is linearly sizeable along a first axis. Specifically, the aperture is expandable and contractible along the first axis. Moreover, the aperture is further linearly sizeable along a second axis. Specifically, the aperture is expandable and contractible along the second axis. In a preferred embodiment the first axis and the second axis are orthogonal to each other.

In an embodiment of the invention, the body comprises a first face plate, a second face plate, a first rear plate, and a second rear plate, the first face plate being releasably attachable to both the first rear plate and the second rear plate, the second face plate being releasably attachable to both the first rear plate and the second rear plate. The first face plate and the second face plate may be substantially identical in construction. Moreover, the first rear plate and the second rear plate may be substantially identical in construction.

The first face plate is attachable to and independently movable relative to both the first rear plate and the second rear plate. Moreover, the second face plate is attachable to and independently movable relative to both the first rear plate and the second rear plate. Specifically, the first face plate is linearly movable relative to the first rear plate along a first axis and the first face plate is linearly movable relative to the second rear plate along a second axis, the first axis and the second axis being orthogonal to each other. Additionally, the second face plate is linearly movable relative to the first rear plate along a first axis and the second face plate is linearly movable relative to the second rear plate along a second axis, the first axis and the second axis being orthogonal to each other.

Specifically, the first face plate is linearly movable relative to the first rear plate along a first axis, the first face plate is linearly movable relative to the second rear plate along a second axis, the second face plate is linearly movable relative to the first rear plate along the second axis, and the second face plate is linearly movable relative to the second rear plate along the first axis. In an embodiment of the invention, the adjustable escutcheon plate according to claim 15, wherein the first axis and the second axis are orthogonal to each other.

The adjustable escutcheon plate of the present invention may further comprise at least one wall anchor. The wall anchor may be releasably attachable to the body. Moreover, in a preferred embodiment, the at least one wall anchor comprised two wall anchors.

### BRIEF DESCRIPTION OF THE SEVERAL VIEWS OF THE DRAWINGS

FIG. 1 is a front perspective view of the present adjustable escutcheon plate, shown in its fully contracted configuration;

FIG. 2 is a front perspective view of the adjustable escutcheon plate of FIG. 1, shown in a substantially fully expanded configuration;

FIG. 3 is an exploded, top plan view of the adjustable escutcheon plate of FIG. 1;

FIG. 4 is an exploded rear view of the adjustable escutcheon plate of FIG. 1;

FIG. 5 an elevated, side view of one of the face plates of the adjustable escutcheon plate of FIG. 1;

FIG. 6 is a perspective view of the anchor and plug assembly of the present adjustable escutcheon plate; and

FIG. 7 is a top plan view of two of the present adjustable escutcheon plates, each being partially cut to fit a particular, two-hole application.

### DETAILED DESCRIPTION OF THE INVENTION

While the present invention is susceptible of embodiment in many different forms, there is shown in the drawings and will herein be described in detail, one specific embodiment, with the understanding that the present disclosure is intended as an exemplification of the principles of the present invention and is not intended to limit the invention to the embodiment illustrated.

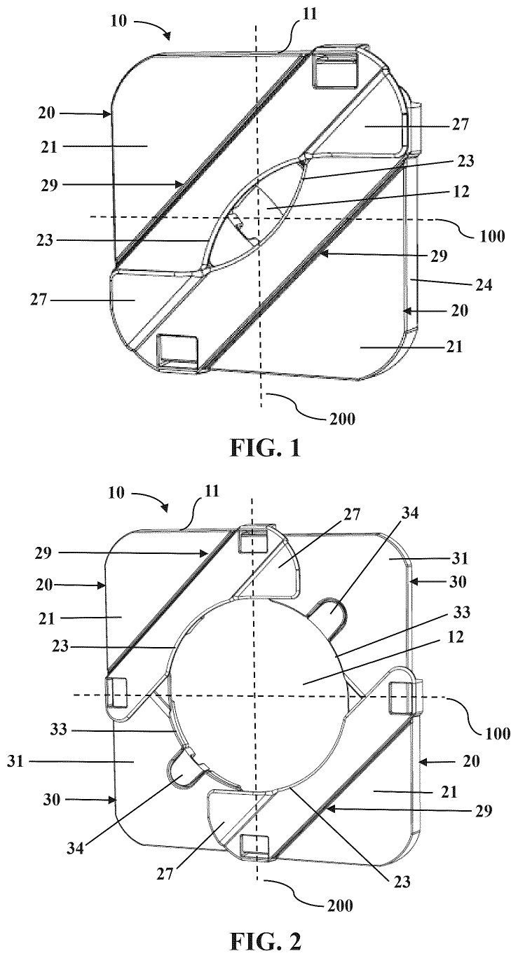

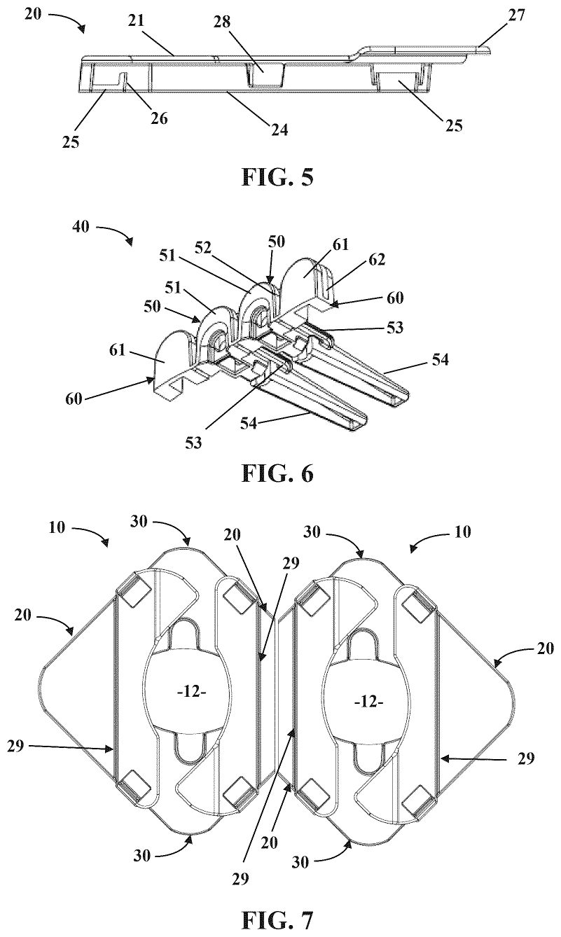

An embodiment of the present adjustable escutcheon plate is shown in FIGS. 1-5 as comprising body 11, having aperture 12 extending therethrough. Body 11 comprises four interlocking components; namely two substantially identical face plates 20, and two substantially identical rear plates 30. It is also contemplated that, in an alternative embodiment, body 11 may comprise more than two face plates and/or more than two rear plates.

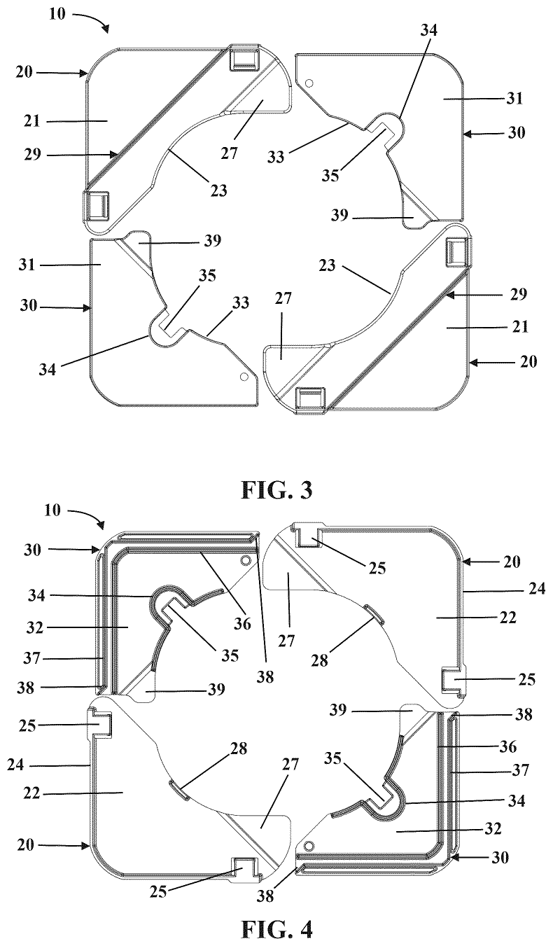

As best seen in FIGS. 3-5, each face plate 20 comprises top surface 21, bottom surface 22, arcuate inner portion 23, and raised step region 27, which is slightly raised, relative to the adjacent surfaces of top surface 21 and bottom surface 22. Each face plate further includes tab member 28 disposed substantially midway along arcuate inner portion 23 and extending vertically from bottom surface 22. Each tab member 28 permits body 11 of escutcheon plate 10 to more securely hug a pipe, tubing or other article disposed within aperture 12. Tab members 28 may also serve to further secure any gasketing material that may be placed between body 11 of escutcheon plate 10 and the associated pipe, tubing, or other article extending through the nearby wall or other surface.

Each face plate 20 further comprises raised outer lip 24, extending from bottom surface 22 along the periphery of two sides of face plate 20, and two substantially L-shaped brackets 25, each extending horizontally from an opposing end of raised outer lip 24. Each bracket 25 terminates at its end opposite raised outer lip 24 in a vertically extending guide 26. As best seen in FIG. 1, raised step region 27 of each face plate 20 permits each face plate 20 to partially overlap the other face plate 20 when body 11 of escutcheon plate 10 is in a relatively contracted configuration.

For certain applications, it may be necessary or desirable to cut off a portion of escutcheon plate 10 in order to achieve a desired fit, most often because of interfering structure proximate the location where escutcheon plate 10 is to be placed. Accordingly, each face plate 20 further includes max-cut line 29 extending across top surface 21. In a preferred embodiment, max-cut line 29 comprises a groove extending across top surface 21. Each max-cut line 29 serves as an indicator of the maximum amount of material that may be removed from escutcheon plate 10, while retaining the operational integrity of the assembled unit. The removal of a portion of body 11 of escutcheon plate 10 by cutting is discussed in additional detail further below.

As best seen in FIGS. 2-4, each rear plate 30 comprises top surface 31, bottom surface 32, arcuate inner portion 33, and dropped step region 39, which is slightly lowered relative to the adjacent surfaces of top surface 31 and bottom surface 32. Dropped step region 39 of each rear plate 30 permits each rear plate 30 to partially overlap the other rear plate 30 when body 11 of escutcheon plate 10 is in a relatively contracted configuration. Each rear plate 30 further comprises recessed region 34 disposed substantially midway along arcuate inner portion 33. Recessed region 35 includes substantially rectangular notch 35.

As best seen in FIG. 4, each rear plate 30 further comprises two colinear rails, each extending vertically from bottom surface 32. In particular, the colinear rails include inner rail 36 and outer rail 37, defining a track therebetween. Outer rail 37 of each rear plate 30 terminates at both ends with tapered leading edge 38.

In a preferred embodiment, each face plate 20 and rear plate 30 may be constructed of powder coated zinc. Other materials, such as aluminum, other metals, or relatively rigid plastics, may alternatively be used. Moreover, for aesthetic purposes, each of face plate 20 and rear plate 30 may be finished in a variety of colors and textures.

Referring to FIG. 6, the present adjustable escutcheon plate 10 may further include a plurality of anchors 50, and/or a plurality of plugs 60. Anchors 50 enable escutcheon plate 50 to be securely attached to an abutting drywall surface. As shown in FIG. 6, multiple anchors 50 and plugs 60 may be injection molded together, using nylon or another suitable material, as a single anchor and plug assembly 40, comprising two anchors 50 and two plugs 60. Individual anchors 50 and plugs 60 may be individually broken off from and separated from anchor and plug assembly 40, as needed for a particular application of adjustable escutcheon plate 10.

Anchor 50 includes head 51 having peripheral slot 52, retaining member 54, and two apposing arms 53 connecting head 51 to retaining member. Peripheral slot 52 extends about three sides of head 51. Head 51 further includes an aperture 55 extending vertically therethrough for accommodating a screw or other threaded fastener. Arms 53 are preferably offset from an axis extending through aperture 55 and retaining member 54, such that extending a fastener through aperture 55 and into contact with retaining member 54 will cause retaining member 54 to pivot relative to head 51 about arms 53.

Plug 60 comprises body 61, having peripheral slot 62 extending about three sides of body 61.

Each anchor 50 and plug 60 may alternatively be press-fit into releasable attachment with an associated rear plate 30. Specifically, either head 51 of anchor 50 or body 61 of plug 60 may be press-fit to recessed region 34 of rear plate 30. When attaching anchor 50 to rear plate 30, notch 35 of rear plate 30 abuts peripheral slot 52 of anchor 50. Plugs 60 serve to occupy the same space proximate notch 35 of rear plate 30 when anchors 50 are not being used for a particular application. When attaching plug 60 to rear plate 30, notch 35 of rear plate 30 abuts peripheral slot 62 of plug 60.

Aperture 12 may be expanded and contracted in size to accommodate objects of varying dimension. In a preferred embodiment, Aperture 12 may closely accommodate objects having diameters ranging from 0.5 inches to 3.0 inches. Referring to FIGS. 1 and 2, the size and shape of aperture 12 may be adjusted in two dimensions. Specifically, aperture 12 may be made smaller or larger in a first dimension by moving each face plate 20 and an associated rear plate 30 away from the other face plate 20 and rear plate 30, by pulling the face plates 20 apart along first axis 100. This in turn, causes one guide 26 of each face plate 20 to travel within its associated track between inner rail 36 and outer rail 37 of an associated rear plate 30, along a path that is colinear to first axis 100.

Additionally, the size and shape of aperture 12 may be made smaller and larger in a second dimension by moving each face plate 20 and an associated rear plate 30 away from the other face plate 20 and rear plate 30, by pulling the face plates 30 apart along second axis 200. This, in turn, causes one guide 26 of each face plate 20 to travel within its associated track between inner rail 36 and outer rail 37 of an associated rear plate 30, along a path that is colinear to second axis 200.

As shown in FIGS. 1 and 2, first axis 100 and second axis 200 are substantially orthogonal to each other. Notably, by adjusting the size of aperture 12 of body 11 by substantially equal movement of face plates 20 and rear plates 30 along first axis 100 and along second axis 200, aperture 12 may be configured to be substantially circular in shape, but of varying diameter and circumference, thereby closely accommodating substantially cylindrical pipes, tubing, or conduit of various diameters. Moreover, by adjusting the size of aperture 12 of body 11 by substantially unequal movements of face plates 20 and rear plates 30 along first axis 100 and along second axis 200, aperture 12 may be configured to take on various noncircular shapes, thereby closely accommodating non-cylindrical pipes, tubing, or conduit, or non-cylindrical groups or bundles of same.

As best seen in FIG. 4, two face plates 20 and two rear plates 30 may be assembled to form body 11 of adjustable escutcheon plate 10 by sliding each guide 26 of each face plate 20 onto an associated track between an adjacent inner rail 36 and outer rail 37 of an associated rear plate 30. Such assembly is facilitated by tapered leading edges 38 of outer rails 37, which serve to direct the movement of each guide 26 onto an associated track. Once so assembled, each bracket 25 serves to inhibit the vertical separation of each face plate 20 from its adjacent rear plates 30. An assembled adjustable escutcheon plate 10 may be disassembled by fully expanding aperture 12 beyond its maximum configuration, by separating each face plate 20 from the other along both axis 100 and axis 200. This, in turn, causes each guide to exit its associated track.

In operation, a disassembled adjustable escutcheon plate 10 is assembled in place, adjacent a wall or other surface through which a pipe, tubing, or other article is extending. Specifically, adjustable escutcheon plate 10 is assembled about the pipe tubing or other article, with rear plates 30 behind face plates 20. During such assembly, both guides 26 of each face plate 20 are linearly advanced into a corresponding track between a corresponding inner rail 36 and a corresponding outer rail 37 of rear plate 30. Tapered leading edge 38 of each outer rail 38 facilitates the initial insertion of each 26 into its corresponding track. One so assembled, aperture 12 of body 11 of escutcheon plate 10 surrounds the associated pipe, tubing, or other article extending through the nearby wall or other surface. At this time, either anchors 50 or plugs 60 may be attached to rear plates 30.

Next, the size of aperture 12 is contracted, by manually gripping each face plate 20, and then bringing each face plate towards the other along both first axis 100 and second axis 200, until arcuate inner portions 23 of face plates 20, and arcuate inner portions 33 of rear plates 30, come into contact with the pipe, tubing, or other article extending through aperture 12. As escutcheon plate 10 is independently adjustable along each of first axis 100 and second axis 200, the size and dimensions of aperture 12 may be contracted either symmetrically or asymmetrically, in order to closely accommodate pipes, tubing, or other articles of a wide variety of shapes and sizes. If desired, steel wool, caulking, or other insulating, sealing, or gasketing materials may be disposed about aperture 12 and the adjacent pipe, tubing or other article. Additionally, in addition to or as an alternative to the use of anchors 50, a suitable adhesive material may be used to affix body 11 of escutcheon plate 10 to an adjacent wall or other surface.

As indicated further above, for certain applications, it may be necessary or desirable to cut off a portion of escutcheon plate 10 in order to achieve a desired fit, most often because of interfering structure proximate the location where escutcheon plate 10 is to be placed. When cutting escutcheon plate 10 for a particular application, escutcheon plate 10 is first contracted to its smallest configuration, with aperture 12 at its minimal size. Next, one or more cuts may be made through body 11 of escutcheon plate 10. Each cut is made simultaneously through a portion of one face plate 20 (either at max-cut line 29, or a position of top surface 21 that is on an opposing side of max-cut line 29, relative to arcuate inner portion 23) and through adjacent, underlying portions of two rear plates 20.

Referring to FIG. 7, multiple escutcheon plates 10 may be used together, with each plate 10 being cut in order to fit a particular application. In the example of FIG. 7, one corner of each of two escutcheon plates 10 has been cut away, outside of respective max-cut lines 29, in order to permit their respective apertures 12 to be placed in relatively close proximity to each other.

Many modifications and variations of the present invention are possible in light of the above teachings. It is therefore to be understood that within the scope of the appended claims, the invention may be practiced other than as specifically described. Various modifications, changes and variations may be made in the arrangement, operation and details of construction of the invention disclosed herein without departing from the spirit and scope of the invention. The present disclosure is intended to exemplify and not limit the invention.

1. An adjustable escutcheon plate, comprising:
a body;
an aperture disposed through the body;
the aperture being sizeable in a first dimension; and
the aperture being sizeable in a second dimension, the second dimension being both orthogonal to and coplanar to the first dimension.

2. (canceled)

3. The adjustable escutcheon plate according to claim 1, wherein the aperture is linearly sizeable along a first axis.

4. The adjustable escutcheon plate according to claim 3, wherein the aperture is expandable and contractible along the first axis.

5. The adjustable escutcheon plate according to claim 3, wherein the aperture is further linearly sizeable along a second axis.

6. The adjustable escutcheon plate according to claim 5, wherein the aperture is expandable and contractible along the second axis.

7. The adjustable escutcheon plate according to claim 5, wherein the first axis and the second axis are orthogonal to each other.

8. An adjustable escutcheon plate, comprising:
a body; and
an aperture disposed through the body;
wherein the body comprises a first face plate, a second face plate, a first rear plate, and a second rear plate, the first face plate being releasably attachable to both the first rear plate and the second rear plate, the second face plate being releasably attachable to both the first rear plate and the second rear plate.

9. The adjustable escutcheon plate according to claim 8, wherein the first face plate and the second face plate are substantially identical in construction.

10. The adjustable escutcheon plate according to claim 8, wherein the first rear plate and the second rear plate are substantially identical in construction.

11. The adjustable escutcheon plate according to claim 8, wherein the first face plate is attachable to and independently movable relative to both the first rear plate and the second rear plate.

12. The adjustable escutcheon plate according to claim 11, wherein the second face plate is attachable to and independently movable relative to both the first rear plate and the second rear plate.

13. The adjustable escutcheon plate according to claim 11, wherein the first face plate is linearly movable relative to the first rear plate along a first axis and the first face plate is linearly movable relative to the second rear plate along a second axis, the first axis and the second axis being orthogonal to each other.

14. The adjustable escutcheon plate according to claim 12, wherein the second face plate is linearly movable relative to the first rear plate along a first axis and the second face plate is linearly movable relative to the second rear plate along a second axis, the first axis and the second axis being orthogonal to each other.

15. The adjustable escutcheon plate according to claim 8, wherein:
the first face plate is linearly movable relative to the first rear plate along a first axis;
the first face plate is linearly movable relative to the second rear plate along a second axis;
the second face plate is linearly movable relative to the first rear plate along the second axis; and
the second face plate is linearly movable relative to the second rear plate along the first axis.

16. The adjustable escutcheon plate according to claim 15, wherein the first axis and the second axis are orthogonal to each other.

17. The adjustable escutcheon plate according to claim 1, further comprising at least one wall anchor.

18. The adjustable escutcheon plate according to claim 17, wherein the at least one wall anchor releasably attachable to the body.

19. The adjustable escutcheon plate according to claim 17, wherein the at least one wall anchor comprised two wall anchors.

20. An adjustable escutcheon plate, comprising:
a body;
an aperture disposed through the body;
the aperture being expandable and contractible along a first axis;
the aperture being expandable and contractible along a second axis; and
the first axis and the second axis being both orthogonal and coplanar to each other.
